(19) United States
(12) Patent Application Publication
(10) Pub. No.: US 2004/0177717 A1
(43) Pub. Date: Sep. 16, 2004

(54) Bicycle crank

(76) Inventor: Cheng-Hsun Chiang, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/386,635

(22) Filed: Mar. 13, 2003

(51) Int. Cl. G05G 1/14

(52) U.S. Cl. 74/594.1

(57) ABSTRACT

A bicycle crank includes a threaded hole defined through an end thereof and a threaded member has a threaded shank which is threadedly engaged with the threaded hole. A flange extends radially from an end of the threaded shank and has two holes through which two fasteners extend and are engaged with receiving holes in a surface of a stepped recess defined in the first side of the crank. A plurality of notches are defined in a periphery of the flange. A ring member is received in a second stepped recess defined in a second side of the crank and has an threaded inner periphery which is threadedly connected to the threaded shank on the second side of the crank. The ring member has a plurality of notches defined in a periphery of the ring member.

### FIELD OF THE INVENTION

The present invention relates to a bicycle crank which has a threaded member connected to an end of the crank so as to be connected to a pedal. The threaded member extends from first side of the crank and is engaged with a ring member on the second side of the crank.

### BACKGROUND OF THE INVENTION

A conventional bicycle crank 10 is shown in FIGS. 4 and 5 and one end of the crank 10 is connected to a bottom bracket and the other end of the crank 10 is connected to a pedal. The end to which the pedal is connected generally includes a threaded hole 111 and a stepped sink recess 11 shares a common axis with the threaded hole 111. A threaded member 12 has a threaded shank 122 which is threadedly engaged with the threaded hole 111 and a flange 13 extends radially from an end of the threaded shank 122 and is rested on the stepped sink recess 11. Two through hole 131 are defined through the flange 13 and two fasteners 14 extend through the two through holes 131 and engaged with two receiving holes defined in the surface of the stepped sink recess 11. By this arrangement, the threaded member 12 is fixed to the crank 10. An inner threaded passage 121 are defined through the threaded shank 122 so as to be connected to a pedal which is not shown. The pedal bears the rider's weight so that it is important to make sure that the structural strength between the threaded member 12 and the crank 10 is strong enough so that the threaded member 12 is not loosened.

The present invention intends to provide a threaded member connected to the crank wherein a ring member is threadedly connected to the threaded shank of the threaded member on the other side of the crank so as to securely position the threaded member.

### SUMMARY OF THE INVENTION

In accordance with one aspect of the present invention, there is provided a bicycle crank which has a threaded hole defined through an end thereof and a first stepped recess is defined in a first side of the crank and shares a common axis with the threaded hole. Two receiving holes are defined in a surface of the first stepped recess. A threaded member has a threaded shank which is threadedly engaged with the threaded hole and a flange extends radially from an end of the threaded shank. Two fasteners extend through two holes in the flange and are engaged with the receiving holes in the surface of the stepped recess. A plurality of notches are defined in a periphery of the flange. A second stepped recess is defined in a second side of the crank and shares a common axis with the threaded hole. A ring member is received in the second stepped recess and has an threaded inner periphery which is threadedly connected to the threaded shank on the second side of the crank. The ring member has a plurality of notches defined in a periphery of the ring member.

The primary object of the present invention is to provide a bicycle crank wherein the threaded member is well positioned by a ring member threadedly connected to the threaded shank on the other side of the bicycle crank.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the crank, the threaded member and the ring member of the present invention;

FIG. 2 is a cross sectional view to show that the threaded member is threadedly connected to the crank by the ring member;

FIG. 3 is a perspective view to show the bicycle crank of the present invention;

FIG. 4 is an exploded view to show a conventional crank and a conventional threaded member, and

FIG. 5 is a cross sectional view to show the conventional threaded member threadedly connected to the conventional crank.

### DETAILED DESCRIPTION OF THE PREFERRED EMBODIMENT

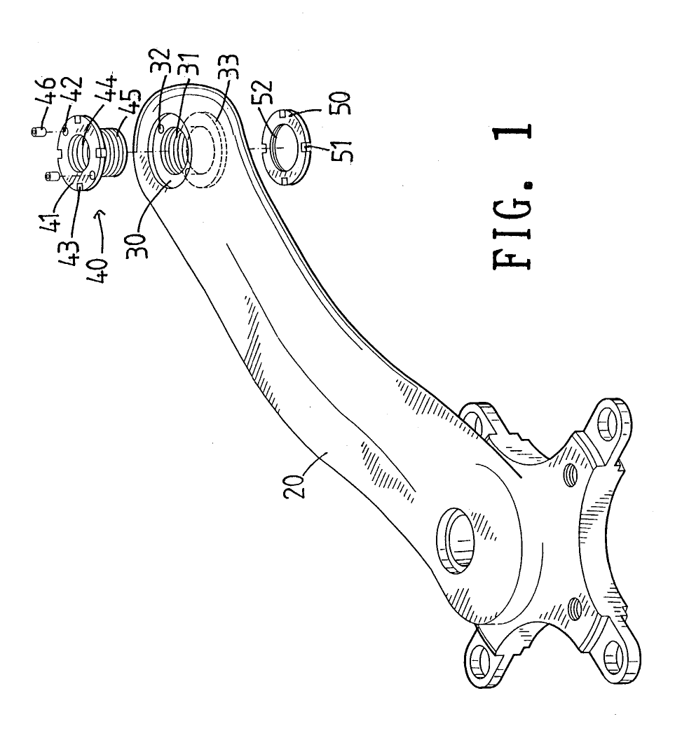

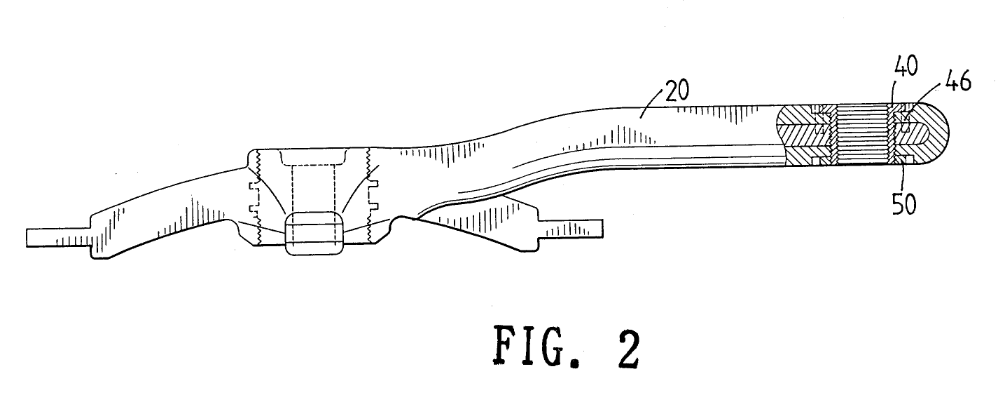

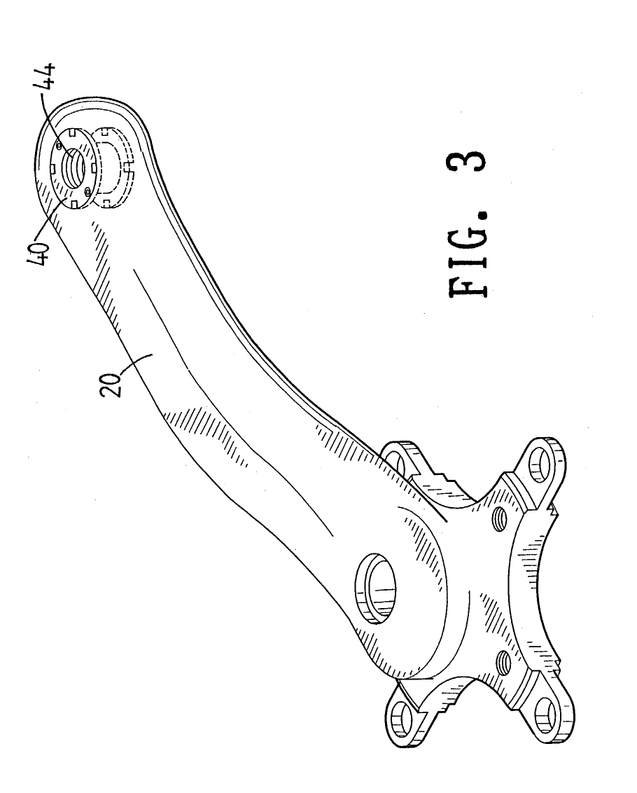

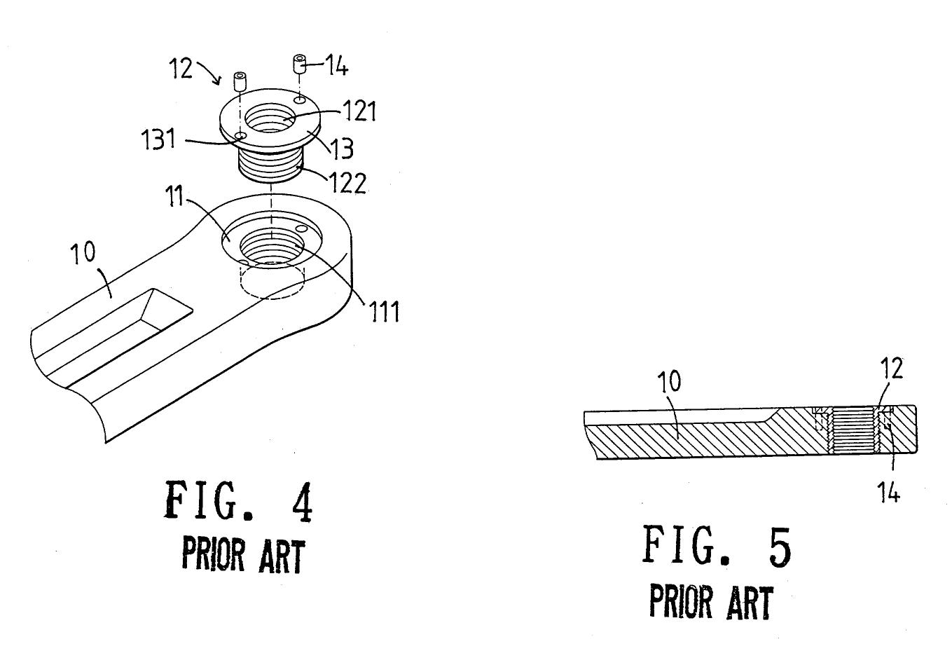

Referring to FIGS. 1 to 3, the bicycle crank 20 of the present invention comprises an end to be fixed to the bottom bracket and the other end of the crank 20 is to be connected to a pedal which is not shown. A threaded hole 31 is defined through the end to be connected with the pedal and a first stepped recess 30 is defined in a first side 21 of the crank 20 and shares a common axis with the threaded hole 31. Two receiving holes 32 are defined in a surface of the first stepped recess 30. A second stepped recess 33 is defined in a second side of the crank 20 and shares a common axis with the threaded hole 31.

A threaded member 40 has threaded shank 45 which is glued with adhesive and is threadedly engaged with the threaded hole 31. A flange 41 extends radially from an end of the threaded shank 45 and two holes 42 are defined through the flange 41. Two fasteners 46 extend through the holes 42 in the flange 41 and are engaged with the receiving holes 32 in the surface of the stepped recess 30. A plurality of notches 43 are defined in a periphery of the flange 41 so that a tool is conveniently engaged with the notches 43 to rotate the threaded member 40. A threaded passage 44 is defined through the threaded shank 45 so as to be connected with a pedal.

A ring member 50 is received in the second stepped recess 33 and has an threaded inner periphery 52 which is threadedly connected to the threaded shank 45 on the second side of the crank 20. The ring member 50 has a plurality of notches 51 defined in a periphery of the ring member 50 for being engaged by a tool. The adhesive is then dried so that the threaded engagement of the threaded member 40 and the threaded hole 31 is secured.

The threaded member 40 is securely positioned by the ring member 50 and the adhesive reinforces the connection between the threaded shank 45, the threaded hole 31 and the ring member 50, so that the threaded member 40 is not loosened even a heavy load is applied.

While we have shown and described the embodiment in accordance with the present invention, it should be clear to those skilled in the art that further embodiments may be made without departing from the scope of the present invention.

What is claimed is:

1. A bicycle crank comprising:
a threaded hole defined through an end thereof and a first stepped recess defined in a first side of the crank and sharing a common axis with the threaded hole, two receiving holes defined in a surface of the first stepped recess, a second stepped recess defined in a second side of the crank and sharing a common axis with the threaded hole;
a threaded member having a threaded shank which is threadedly engaged with the threaded hole and a flange extending radially from an end of the threaded shank, two holes defined through the flange and two fasteners extending through the holes in the flange and engaged with the receiving holes in the surface of the stepped recess, a plurality of notches defined in a periphery of the flange, and
a ring member received in the second stepped recess and having an threaded inner periphery which is threadedly connected to the threaded shank on the second side of the crank, the ring member having a plurality of notches defined in a periphery of the ring member.

2. The bicycle crank as claimed in claim 1, wherein adhesive is spread to the threaded shank.
